(19) United States
(12) Patent Application Publication
(10) Pub. No.: US 2002/0044090 A1
(43) Pub. Date: Apr. 18, 2002

(54) Antenna arrangement for mobile telephones

(75) Inventors: Achim Bahr, Viersen (DE); Dirk Manteuffel, Moers (DE); Jose Marie Baro, Taverny (FR)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/941,731

(22) Filed: Aug. 30, 2001

(30) Foreign Application Priority Data
Oct. 13, 2000 (DE) 100 50 902.9

(51) Int. Cl. H01Q 1/24; H01Q 21/00

(52) U.S. Cl. 343/700 MS; 343/867

(57) ABSTRACT

An antenna arrangement with an earth plate with a plurality of radiators which are arranged in parallel to the earth plate at a distance therefrom, where the radiators for covering a given frequency range have a similar length and are adjacent and parallel to one another, a first terminal of each radiator is arranged in the region of the respective one end of each radiator and is connected to the earth plate via a first connection, the said first connections are closely adjacent to one another or coincide, and a second terminal for a feed line is provided on reach radiator at a distance from its first terminal, wherein the radiator has the form of a flat loop comprising two closely adjacent, long conductors which are connected at adjacent ends by a short conductor, and the second terminals are provided in the region of the respective other end of each radiator, and that the total length of each individual radiator corresponds approximately to ½ wavelength in the given frequency range.

### BACKGROUND OF THE INVENTION

The invention is based on a priority application DE 100 50 902.9 which is hereby incorporated by reference.

The invention relates to an antenna arrangement with an earth plate and with a plurality of radiators which are arranged in parallel to the earth plate at a distance therefrom, wherein the radiators for covering a given frequency range have a similar length and are adjacent to one another and in parallel to one another, a first terminal of each radiator is arranged in the region of the respective one end of each radiator and is connected to the earth plate via a first connection, the foresaid first connections are closely adjacent to one another or coincide, and wherein a second terminal for a feed line is provided on each radiator at a distance from its first terminal, according to the preamble of claim 1.

An antenna arrangement of this kind is known for example from the publication EP 0 884 796 A2, FIG. 61. In the known arrangement, for two frequency bands, in each instance a plurality of radiators of slightly differing length are arranged substantially parallel to one another at a distance from an earth plate and in parallel thereto. The radiators are bent in order that they can be accommodated in a relatively small surface area. The feeding of each radiator takes place at a short distance from that end of the radiator which is connected to the earth plate. The other ends of the radiators are free. The length of the individual radiators should correspond approximately to one quarter of the respective operating wavelength.

The known antenna is very low-ohmic at the lambda/4 resonance, for which reason it is necessary to select a separate feed point with a higher impedance level which generally must be additionally adapted. The bandwidth of the known arrangement is limited (lambda is the wavelength in the frequency range of interest).

Therefore the object of the invention is to provide an arrangement of the type described in the introduction which requires no adaptive measures which could limit the bandwidth.

### SUMMARY OF THE INVENTION

In the invention this object is achieved by the features of the characterising part of claim 1 in that each radiator (13, 14; 51a, 51b; 52a, 52b) has the form of a flat loop comprising two closely adjacent, long conductors which are connected at adjacent ends by a short conductor, and the second terminals are provided in the region of the respective other end of each radiator, and that the overall length of each individual radiator corresponds approximately to ½ wavelength (=lambda/2) in the given frequency range.

If only one of the radiators is considered, in accordance with the invention this is consequently fed at one of its ends, while its other end is connected to the earth plate. In contrast to a folded semi-dipole which is arranged at right angles to an earth plate or conductive plane and one of the two ends of which is connected to the earth plate while the other end serves as feed terminal, where the total conductor length amounts to lambda/2, in accordance with the invention the radiator is arranged in parallel to the earth plate and at a relatively short distance therefrom (in comparison to the wavelength). This folded semi-dipole will also be referred to in the following as folded monopole. Due to the arrangement of the radiator element in parallel to an earth plate, on the one hand the input impedance is smaller than in the case of the arrangement at right angles to an earth plate. On the other hand, in the provided arrangement this characteristic serves to prevent a folded monopole possessing an input impedance which is a factor 4 higher than a conventional dipole. This additionally facilitates the parallel connection of a plurality of radiator elements (namely folded monopoles) to increase the bandwidth without the input impedance falling too much due to this parallel connection. In particular the input impedance can be of a value which is standard for the feeding of antennae and therefore can easily be connected to a circuit provided for feed purposes, for example a transmitter output circuit or a receiving circuit.

In an embodiment of the invention, two or more radiators provided for one single frequency range have the same length and thus, considered individually, have the same resonance frequency. The close coupling results in a resonance curve which is broader than in the case of a single radiator. The broadening of the resonance curve can be furthered in that, in accordance with an embodiment of the invention, the lengths of the individual radiators are different and the individual radiators thus have a different resonance frequency.

In embodiments of the invention the radiators are bent. This facilitates a spacesaving arrangement.

To cover an additional, different frequency range, in embodiments of the invention a further number of radiators are provided whose length is adapted to the further frequency range and which moreover are designed in accordance with the invention.

A mobile telephone comprising an antenna arrangement according to the invention also forms part of the invention.

### BRIEF DESCRIPTION OF THE DRAWINGS

Further features and advantages of the invention are described in the following description of exemplary embodiments of the invention with reference to the drawing which illustrates essential details of the invention, and the claims. The individual features can in each case be implemented individually or jointly in any combination in an embodiment of the invention.

In the drawing:

FIG. 1a is a simplified diagram of an antenna arrangement for a single frequency band with two radiators;

FIG. 1b illustrates an arrangement which is similar to

FIG. 1a

in which however the terminals of the rear radiator are transposed compared to FIG. 1a;

FIG. 1c illustrates an arrangement derived from FIG. 1b in which the two parts of the two radiators directly adjacent to one another are combined to form a single conductor path of double the width compared to FIG. 1a and 1b;

FIG. 2 illustrates an antenna arrangement with a total of four radiators, where two radiators are intended for a band with a lower frequency and two further radiators for a band with a higher frequency;

FIG. 3 is a simplified view of a mobile telephone, partially sectioned, with an antenna arrangement according to FIG. 2 accommodated in the upper part of the mobile telephone;

FIG. 4 illustrates an antenna arrangement with a total of four radiators, where two radiators are intended for a band with a lower frequency and two further radiators for a band with a higher frequency, and all the radiators are multiply bent and partially project beyond an earth plate.

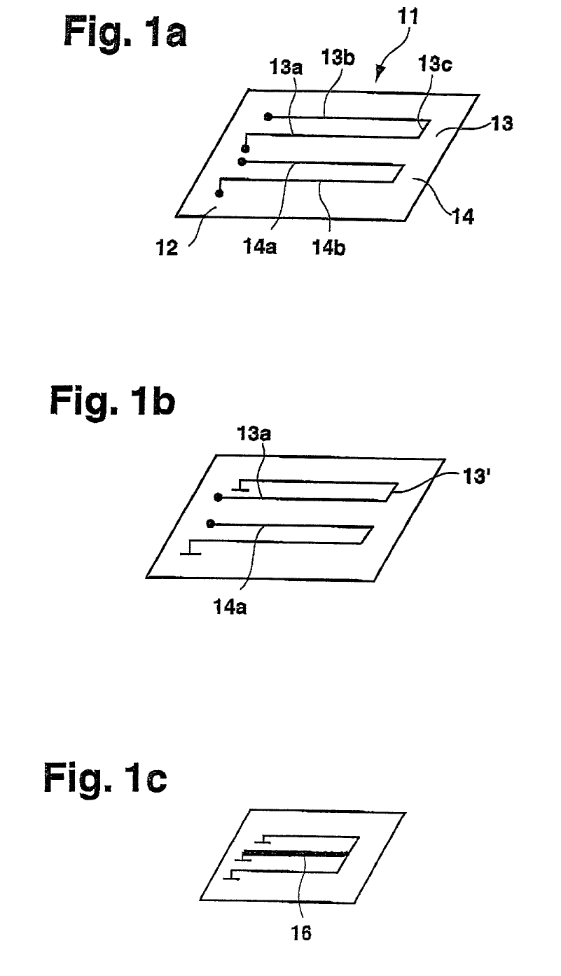

In the arrangement according to FIG. 1a, an antenna arrangement 11 comprises a conductive earth plate 12 and, in parallel thereto and at a distance therefrom, two radiators 13 and 14 of entirely identical formation are arranged at a distance from one another. Therefore it is sufficient to refer to the radiator 13. This substantially consists of an elongate loop consisting of two conductor sections 13a (at the front of FIG. 1a) and 13b (at the back of FIG. 1a) arranged in parallel to one another which are conductively connected to one another in FIG. 1a on the right-hand side by a section 13c. The left-hand end of the radiator section 13a is conductively connected to the earth plate 12 while the left-hand end of the other radiator section 13b forms the feed terminal of the radiator 13. The arrangement in FIG. 1a, where the rear radiator section 13b comprises the feed terminal, also applies to the radiator 14. In practice the illustrated arrangement is implemented such that an insulating plate made of low-loss material and originally metallized on two sides is etched on its upper side such that the conductor paths of the radiators 13 and 14 result. The terminals to be connected to the earth plate 12 are then through-contacted to the lower metallization of this insulating plate which forms the earth plate. In the embodiments of the invention it is provided that the two other terminals, namely the feed terminals, pass downwards through the insulating plate and on the underneath the metallization is naturally cut out in the region of the opening of this passage so that a feed line can be connected here.

As the insulating plate has a uniform thickness, all the radiator parts 13a, 13b, 14a and 14b are arranged at the same distance from the circuit board and are thus parallel thereto; furthermore they are parallel to one another; finally the mutual spacing between the two radiator sections of each individual radiator 13 and 14 compared to the wavelength in the frequency range of interest is very small, in particular smaller than one tenth of the wavelength. The mutual spacing between the two radiators 13 and 14 is also selected to be sufficiently small that a coupling of the desired degree results between the two radiators.

Although the two radiators 13 and 14 considered individually have the same resonance frequency, the coupling results in a widening of the resonance curve compared to the case of a single radiator as is known per se in band filters. The length of each of the radiator sections 13a and 13b corresponds approximately to the length of a quarter wavelength in operation in the provided frequency range.

The unwound length of the total radiator therefore corresponds to half a wavelength. The high-frequency currents in the long radiator sections extending in parallel to the circuit board each flow in the same direction. Due to the reflection of the antenna arrangement on the earth plate 12, the behaviour of the antenna arrangement 11 in terms of its radiation characteristic is as if the earth plate 12 were not present and instead two further radiators were arranged mirrorsymmetrically to the radiators 13 and 14, the currents of said further radiators flowing in the reverse direction to the radiator sections actually present.

In the arrangement shown in FIG. 1b, the two terminals of the more rearwardly arranged radiator, which here bears the reference numeral 13′, are transposed in terms of earth terminal and feed line terminal. Consequently the two radiator sections 13a and 14a are arranged directly beside one another and are commonly connected to the feed line at their left-hand end in FIG. 1b.

In the arrangement according to FIG. 1c, these two mutually adjacent radiator sections 13a and 14a as shown in FIG. 1b are replaced by a common conductive section 16 which has double the width of the conductor paths in each case formed by the radiator sections 13a and 14a in FIG. 1b.

FIGS. 1a to 1c illustrate antenna arrangements which are suitable for operation in one single band. In place of the radiators 13 and 14 of precisely equal length shown therein, the radiators could also possess a different length so that the radiators, considered individually, already have a different resonance frequency in order to further the attainment of a resonance curve in the desired width with the aid of an appropriately close coupling of the radiators.

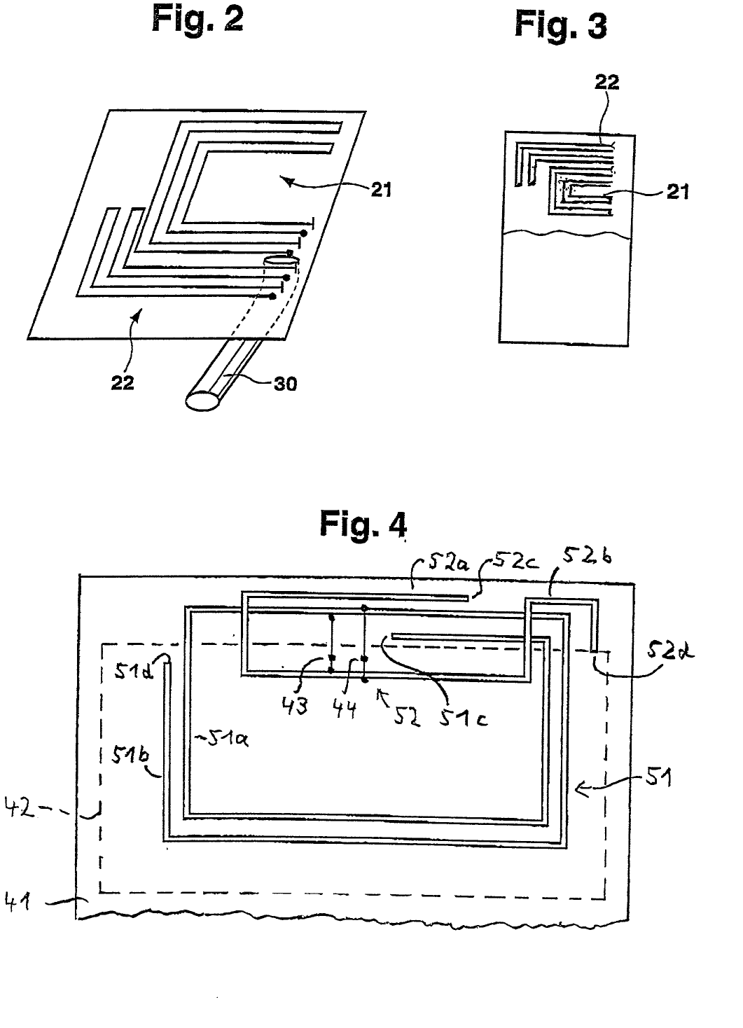

In the multi-band antenna arrangement according to FIG. 2, two different antenna arrangements dimensioned for two different frequency bands are commonly provided on an insulating plate with an underlying earth plate. As also in FIG. 1a to 1c, each of these antenna arrangements comprises two radiators which, as already explained, comprise two closely adjacent conductor sections extending parallel to one another which are interconnected at one end and at their other ends are to be connected to the earth plate and to a feed line respectively.

In order that, with the frequency ranges commonly in use at the present time and with standard present-day mobile telephone sizes, the antenna arrangements can be accommodated in devices of this kind, in particular when operation in the region of approximately 900 MHz and approximately 1800 MHz is intended, the individual radiators are singly or multiply bent by in each case 90° in contrast to FIG. 1a to 1c in which they extend in a straight line. If the arrangement is such that, in an arrangement substantially parallel to a rectangular earth plate, the ends and beginnings of the radiators each terminate at the same distance from the edge of the earth plate, as shown in FIG. 2, the two radiators which form part of a single antenna arrangement thus have a somewhat different length because the one radiator is arranged somewhat inside the other so to speak. The smaller the distance between the two radiator sections, the smaller the distance between the two radiators and the smaller the conductor width of the individual radiator sections, then the smaller also is the difference in length between the two individual radiators.

In FIG. 2 the upper antenna arrangement bearing the general reference 21 is provided for a low frequency range, in the example for a range for mobile telephones in the 900 MHz-band, e.g. according to the GSM 900 standard. The individual radiators of this antenna arrangement have a longer length than in the other antenna arrangement 22 in FIG. 2. The lengths of the radiators of the radiator arrangement 22 are therefore half as long as the lengths of the radiators in the arrangement 21, as the antenna arrangement 22 is intended for a frequency range in the 1800 MHz band. It will be obvious that, with only minor changes, instead the antenna arrangement 22 can also be provided for a frequency range for GSM 1900 (1900 MHz band).

FIG. 2 also schematically illustrates a feed cable which is shown as a coaxial cable and which is connected from beneath to the antenna arrangement, where the sheath of the coaxial cable 30 is to be connected to the earth plate and the central conductor of the coaxial cable is to be connected to the feed terminals of the individual radiators.

When the antenna arrangement according to FIG. 2 is operated in the lower frequency range (as mentioned for example GSM 900), the antenna arrangement 21 is operated at least close to the resonance frequency and the antenna arrangement 22 is operated well below its resonance frequency so that the antenna arrangement 22 acts like a load on the terminal of the antenna arrangement 21. This influence can readily be taken into account in the feeding of the antenna arrangement 21. Conversely, when the antenna arrangement according to FIG. 2 is operated at the high resonance frequency for which the antenna arrangement 22 is provided, the other antenna arrangement 21 is possibly at a higher resonance in the case of a frequency of this kind.

If this gives rise to undesired influences, for example a sharp resonance curve or a reduced bandwidth, these influences can be counteracted by several measures (individually or in combination):

1. Orthogonal positioning of the radiator elements of the antenna arrangements 21 and 22.

2. Reduction of the coupling between the radiator elements of the antenna arrangements 21 and 22 by the greatest possible physical separation.

3. Positioning of the radiator elements of the antenna arrangement 22 such that they project beyond the earth plate; this also applies to the antenna arrangement 21.

FIG. 3 is a highly simplified diagram of the position of an antenna arrangement according to FIG. 2 in a mobile telephone which can be comfortably held in a hand. The antenna arrangement is accommodated in the upper region of the mobile telephone and the orientation of the antenna arrangement is such that the feed terminals, which simultaneously constitute the locations of the greatest current flow in the radiators, are situated as high up as possible in the device.

It will be obvious that the formation of the bend as a letter L as provided for the antenna arrangement 22, or as a letter U as provided for the antenna arrangement 21 is of an exemplary nature and can be replaced by other configurations in which the radiators are bent or wound up in any way.

In the case of the arrangement according to FIG. 4 provided for two frequency bands, the structure of the radiators visible in FIG. 4 is arranged in the form of different layers of a carrier material. However to simplify the diagram, all the radiators are shown as being fully visible to the observer. The thus formed multilayer plate 41 rests on an earth plate 42. In the example the earth plate 42 is the fundamentally continuous, rear-side metallization of a circuit board, whose other side forms at least parts of a mobile telephone circuit. The circuit elements of this circuit therefore are situated beneath the earth plate 42 in the plan view according to FIG. 4.

The feeding of all the radiator elements takes place via a terminal 43, and the bonding to earth for all the radiator elements takes place via a terminal 44 which is connected to the earth plate 42. For the operating frequency range with a longer wavelength, an antenna arrangement 51 comprising two radiator elements 51a and 51b in the form of folded monopoles is provided. Each of these radiator elements is substantially formed by two conductor paths extending at a close distance and in parallel to one another, and at the end of the radiators the two foresaid conductor paths are each connected to one another by a respective short-circuit 51c and 51d. For the operating frequency range with a shorter wavelength, an antenna arrangement 52 is provided which, in the direction of view of the observer in FIG. 4, lies above the plane in which the antenna arrangement 51 is arranged. This spatial arrangement can also clearly be seen from the drawing.

However, in the following, in the description of the configuration of FIG. 4, the terms above and below and right and left do not relate to the actual spatial arrangement but to FIG. 4 as viewed by the observer. In accordance with this terminology for example the terminal 43 is situated further downwards and Further to the left than the short-circuit connection 52c of the radiators 52a.

The two radiators 51a and 51b of the antenna arrangement 51 continue seamlessly into one another with no bends, this junction between the two radiators being formed in the case of the one conductor by the connection point at which the connection to the terminal 43 is established. For the other conductor of the two radiator elements 51a and 51b, this junction occurs at the connection point of the foresaid conductor to the terminal 44. Like the first-mentioned connection to the terminal 43, this last mentioned connection is situated above the terminals 43 and 44 in FIG. 4. The connection to the two radiators 52a and 52b of the antenna arrangement 52 occurs below these foresaid terminals. In the whole of FIG. 4 no cross-over of lines signifies an electrical connection.

The antenna arrangement 51 as a whole is formed by an arrangement, shortcircuited at both its ends, of two closely adjacent parallel conductors which are bent at right angles in the same direction a total of seven times, resulting in a spiral-like arrangement comprising somewhat less than two turns. Here the two radiators 51a and 51b are spaced from one another by a distance which is very much smaller than the short side of the rectangle which is substantially filled by this antenna arrangement 51.

The antenna arrangement 52 lies partially inside and partially outside (considered in the plan view according to FIG. 4) the antenna arrangement 51. Commencing with the short-circuit 52c right at the top in FIG. 4, the two conductors extending in parallel at a short distance from one another and forming this antenna arrangement 52 extend firstly to the left in parallel with the uppermost arm of the antenna arrangement 51, then downwards with a rectangular bend, then to the right into the vicinity of the vertical part of the more inwardly situated radiator 51a, then upwards with a 90° bend in the same direction as previously up to the same level as the first section 52a of this antenna arrangement, then further to the right with a 90° bend in the other direction, and finally downwards with a 90° bend. This last mentioned downwardly extending section of the radiator 52b terminates approximately where the upper edge of the earth plate 42 likewise terminates. Consequently, of the antenna arrangement 52, more than half of the total radiator length extends into a region which (in the actual three-dimensional arrangement) does not lie above the earth plate 52 but is laterally offset outside it. Also in this region the antenna arrangement is supported by the multi-layer circuit board 41. Of the first-mentioned antenna arrangement 51, the uppermost radiator section forming the long side of a rectangle extends outside the earth plate, and likewise that part of the radiator element 51a adjoining the short-circuit 51c and extending in parallel to the above mentioned radiator section, as well as the sections of the conductor elements which are directly adjacent to these elements, extend at right angles thereto and establish the connection to the other parts.

Overall the mutual arrangement of the antenna arrangements 51 and 52 can also in part be described in that the two arrangements are relatively eccentric to one another, the arrangement for the range with a short operating wavelength extending percentage-wise very much further beyond the earth plate 52 than the other antenna arrangement.

Thus, in respect of some of its parts, the antenna arrangement 52 is situated at a relatively long distance from adjacent parts of the antenna arrangement 51 and where cross-overs are required between the different antenna arrangements these occur at right angles and thus with small coupling. The antenna arrangement 4 is provided for a mobile telephone according to the GSM 900 and GSM 1800 standards, but, as will be readily understandable, can easily be modified for the GSM 900 and GSM 1900 range.

As a parallel arrangement of the radiator elements with a small spacing is largely avoided, strong undesired coupling is avoided. Therefore no serious interference occurs in operation in the 1800 MHz range in which the antenna arrangement intended for the 900 MHz range can be in resonance.

1. An antenna arrangement with an earth plate and with a plurality of radiators which are arranged in parallel to the earth plate at a distance therefrom, wherein the radiators for covering a given frequency range have a similar length and are adjacent to one another and parallel to one another, a first terminal of each radiator is arranged in the region of the respective one end of each radiator and is connected to the earth plate via a first connection, the said first connections are closely adjacent to one another or coincide, and wherein a second terminal for a feed line is provided on each radiator at a distance from its first terminal, wherein the radiator has the form of a flat loop comprising two closely adjacent long conductors which are connected at adjacent ends by a short conductor, and the second terminals are provided in the region of the respective other end of each radiator, and that the total length of each individual radiator corresponds to approximately ½ wavelength in the given frequency range.

2. An antenna arrangement according to claim 2, wherein the radiators are bent.

3. An antenna arrangement according to claim 1, wherein the radiators are of different length.

4. An antenna arrangement according to claim 1, wherein in order to cover an additional, different frequency range, a further number of radiators according to one of the preceding claims are provided, the length of which is adapted to the further frequency range.

5. An antenna arrangement according to claim 4, wherein in order to avoid undesired influences of the longer radiators when the antenna arrangement is operated in the range of the resonance frequency of the shorter radiators, at least one of the following measures is provided:
a) separating feed lines for the two frequency ranges,
b) orthogonal positioning of the radiator elements of the antenna arrangements,
c) reduction of the coupling between the radiator elements of the antenna arrangements by the largest possible spatial separation,
d) positioning of the radiator elements of at least one antenna arrangement such that they project beyond the earth plate.

6. A mobile telephone, characterised by an antenna arrangement according to claim 1.
